(19) United States
(12) Patent Application Publication
(10) Pub. No.: US 2024/0120469 A1
(43) Pub. Date: Apr. 11, 2024

(54) MANUFACTURING OF SOLID-STATE ELECTRODE LAMINATE

(71) Applicant: Solid Power Operating, Inc., Lousville, CO (US)

(72) Inventors: Brandon KELLY, Longmont, CO (US); Uday Kasavajjula, Superior, CO (US); Sikandar Iqbal, Louisville, CO (US); A Yang, Erie, CO (US)

(21) Appl. No.: 18/377,255

(22) Filed: Oct. 5, 2023

Related U.S. Application Data
(60) Provisional application No. 63/413,526, filed on Oct. 5, 2022.

(51) Int. Cl. H01M 4/36; H01M 4/04; H01M 4/66

(52) U.S. Cl. CPC H01M 4/366; H01M 4/0407; H01M 4/0435; H01M 4/661; H01M 2300/0068

(57) ABSTRACT

Aspects involve systems and methods for producing an electrode laminate for a battery that includes a stack of a center electrode layer, a solid-state electrolyte (SSE) layer, and carrier film layer (such as an aluminum foil layer), which is removed prior to use in a cell. To laminate the lithium foil layer to the SSE layers, the stack may be fed through a calender press device comprising a first roller and a second roller. The rollers exert a compressive force on the stack to laminate the layers together while also reducing the porosity of the materials within the stack (densifying), enhancing material contact, causing some layers to adhere or otherwise laminate, and/or also causing some layers to partially separate. The pressure applied to the stack by the calender press may correlate to a spacing between the first roller and the second roller, which may be adjustable by a controller.

### CROSS-REFERENCE TO RELATED APPLICATION

This application is related to and claims priority under 35 U.S.C. § 119(e) from U.S. Patent Application No. 63/413,526, filed Oct. 5, 2022, titled “Manufacturing of Solid-State Electrode Laminate,” the entire contents of which is incorporated herein by reference for all purposes.

### TECHNICAL FIELD

Various embodiments described herein relate to the field of solid-state primary and secondary electrochemical cells, electrodes, and electrode materials, and the corresponding methods of making and using the same.

### BACKGROUND AND INTRODUCTION

The ever-increasing number and diversity of mobile devices, the evolution of hybrid/electric automobiles, and the development of Internet-of-Things devices, among other things, is driving ever greater need for battery technologies with improved reliability, capacity, thermal characteristics, lifetime and recharge performance. Currently, although lithium solid-state battery technologies offer potential increases in safety, packaging efficiency, and enable new high-energy chemistries as compared to other types of batteries, improvements in lithium battery technologies and other solid-state battery technologies are needed, especially improvements in lower cost production.

It is with these observations in mind, among others, that various aspects of the present disclosure were conceived and developed.

### SUMMARY

One aspect of the present disclosure relates to a method for manufacturing a battery electrode. The method may include the features of casting a first solid-state electrolyte (SSE) layer onto a first carrier film and a second SSE layer onto a second carrier film, layering a conductive foil between and adjacent to the first SSE layer and the second SSE layer as an electrode stack, and pressing the electrode stack through a pressing device, wherein the pressing device laminates the first SSE layer and the second SSE layer to the conductive foil.

Another aspect of the present disclosure relates to an electrode for a battery. The electrode may include a first solid-state electrolyte (SSE) layer comprising a solid electrolyte material and a binder, a conductive layer adjacent to the first SSE layer, and a second SSE layer comprising the solid electrolyte material and the binder and adjacent to the conductive layer, wherein the conductive layer is laminated to the first SSE layer and the second SSE by pressure applied to the layers from a calender press.

Yet another aspect of the present disclosure relates to a method for manufacturing a battery electrode. The method may include the operation of compressing an electrode stack comprising a first carrier film layer, a first solid-state electrolyte (SSE) layer adjacent the first carrier film layer, a conductive foil adjacent the first SSE layer, a second SSE layer adjacent the conductive foil, and a second carrier film adjacent the second SSE layer, wherein the compression laminates the first SSE layer and the second SSE layer to the conductive foil.

### BRIEF DESCRIPTION OF THE DRAWINGS

The various objects, features, and advantages of the present disclosure set forth herein will be apparent from the following description of embodiments of those inventive concepts, as illustrated in the accompanying drawings. It should be noted that the drawings are not necessarily to scale and may be representative of various features of an embodiment, the emphasis being placed on illustrating the principles and other aspects of the inventive concepts. Also, in the drawings the like reference characters may refer to the same parts or similar throughout the different views. It is intended that the embodiments and figures disclosed herein are to be considered illustrative rather than limiting.

FIG. 1 is a diagram illustrating manufacturing a solid-state electrode laminate using a calender press, according to aspects of the present disclosure.

FIGS. 2A and 2B are diagrams illustrating a notched calender press for manufacturing separated solid-state electrode laminates, according to aspects of the present disclosure.

FIG. 3 is a diagram illustrating manufacturing a solid-state electrode laminate with cut-outs for separate laminated sections, according to aspects of the present disclosure.

FIG. 4 is a flowchart of a method for manufacturing a solid-state electrode laminate using a calender press, according to aspects of the present disclosure.

FIG. 5 is a block diagram illustrating an example of a computing system which may be used in implementing embodiments of the present disclosure.

### DETAILED DESCRIPTION

Lithium-based rechargeable batteries are popular to power many forms of modern electronics and have the capability to serve as the power source for hybrid and fully electric vehicles. State-of-the-art lithium-based rechargeable batteries typically employ a carbon-based anode to store lithium ions, such as a graphite anode. In these anodes, lithium ions are stored by intercalating between planes of carbon atoms that compose graphite particles. Cathodes of such rechargeable batteries may contain transition metal ions, such as nickel, cobalt, and aluminum, among others. Such electrodes have been tailored to confer acceptable performance in modern lithium-ion batteries. However, carbon-based anodes are reaching maturity in terms of their lithium-ion storage.

Traditional electrode manufacturing for lithium-based rechargeable batteries can be a time-consuming and inefficient process. To manufacture a graphite anode, for example, a graphite slurry is produced that includes graphite components, binders, and some kind of solvent that is then applied to a metal foil, such as a copper foil, by a process of extrusion, rolling, or tape-casting, depending on selected process and solvents used. After application, the coated graphite mixture is dried by evaporation of solvents, such as by running the coated slurry through an oven or other drying machine. Cathode construction may occur in a similar manner with an aluminum foil used.

This process for generating a dried electrode sheet may have a high porosity that is detrimental to an efficient operation within a rechargeable battery. Therefore, the sheet is often passed through a calender press device to reduce the porosity of the materials. The pressed electrode sheet may then be cut into desired lengths. For use in a battery cell (such as a cylindrical cell, prismatic cell, pouch cell, and the like), a stack comprising a separator positioned between the anode sheet and the cathode sheet discussed above is then produced from the separate cathode sheet, anode sheet and separator. Typical separators use some type of polyethylene material with a ceramic coating to separate the anode and the cathode and prevent shorts within the battery. A liquid electrolyte then surrounds and penetrates the produced stack within the battery cell. However, each of the multiple steps of the above process to produce the battery stack may introduce inefficiencies or opportunities for flaws to be introduced in the battery design, resulting in shorter battery life or potential for a short within the battery itself.

Aspects of the present disclosure involve systems and methods for producing an electrode laminate for a battery that includes a solid-state separator layer that may replace a traditional separator layer and liquid electrolyte used in conventional liquid electrolyte battery architectures. In one example, an electrode may comprise a stack of a center electrode layer, a solid-state electrolyte (SSE) layer, and carrier film layer, which is removed prior to use in a cell. The carrier film layer may include, in various implementations, a thin foil of aluminum, copper, nickel, or stainless steel or a thin layer of a polymer material. In one implementation, the center electrode layer may be lithium foil and the layers may be arranged initially in an Aluminum-SSE-Lithium-SSE-Aluminum stack. In other implementations, the center electrode may be a lithium alloy such as Li—Al (Lithium-Aluminum), Li—Mg (Lithium-Magnesium), Li—In ((Lithium-Indium). The lithium content of the center electrode alloys may be, in some examples, 5% to 99.9%, 10% to 99%, 20% to 98%, or 50% to 95%. The SSE layer may comprise a sulfide-based solid electrolyte material and binder cast onto the aluminum foil. To laminate the lithium foil layer to the SSE layers, the stack may be fed through a calender press device comprising a first roller and a second roller. The rollers exert a compressive force on the stack to laminate the layers together while also reducing the porosity of the materials within the stack (densifying), enhancing material contact, causing some layers to adhere or otherwise laminate, and/or also causing some layers to partially or completely separate (e.g., the outer aluminum foil layers). The pressure applied to the stack by the calender press may correlate to a spacing between the first roller and the second roller, which may be adjustable by a controller. The controller may adjust the compressive force of the calender press based on feedback information received from one or more sensor components associated with the calender press. In one implementation, the controller may adjust the spacing to adjust the compressive force based on the thickness of one or more of the layers of the stack.

Other aspects of the present disclosure involve systems and methods for manufacturing an electrode laminate for a battery that includes a solid-state separator layer using a notched calender roller. The roller of the calender press may include a notch in the surface of the roller along its length. During pressing of the electrode stack, the notch of the roller, when aligned with the stack, may not apply a laminating pressure to the stack of layers to generate a portion of the laminated stack in which the SSE layer does not adhere to the lithium center foil. When the aluminum layer is peeled from or otherwise removed from the stack, the SSE layer previously coated onto the aluminum may be removed with the aluminum, thereby creating portions of the stack of only the inner electrode layer (e.g., the lithium foil layer). Utilizing the notched roller, alternating sections of an SSE layer followed by a section of bare lithium foil may be generated. The total length of SSE and lithium can be controlled through altering a diameter of the notched roller and/or defining the dimensions (width, length and/or shape) of the notch. After the layers are laminated and the aluminum foil is removed, the bare lithium foil portions where the aluminum foil and SSE have been removed, may be cut to produce a single SSE-Li-SSE sheet of a desired length with bare lithium conductive foil tabs on the ends. These and other manufacturing systems and methods are described herein for generating a solid-state electrode laminate for use in a battery configuration.

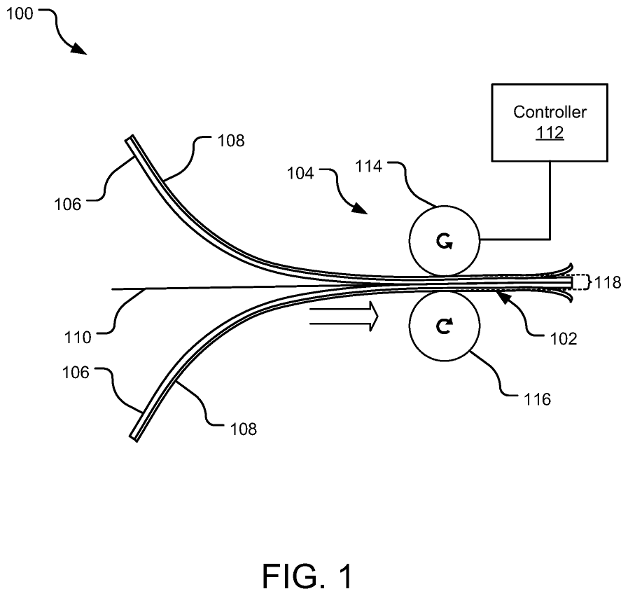

FIG. 1 is a diagram 100 illustrating manufacturing a solid-state electrode laminate 102 using a calender press device 104, according to aspects of the present disclosure. In one implementation, the solid-state electrode laminate 102 may include two separator layers of a composite blend of a solid-state electrolyte (SSE) and a binder. The SSE 106 may be coated as a thin layer on a carrier film 108. In one example, the carrier film 108 may be an aluminum foil, although other materials may be used. A thin foil of lithium metal 110 may be placed between two facing SSE layers 106. To generate an anode stack, two different sheets of the SSE 106 on foil 108 may be oriented such that the SSE layers are facing each other with the lithium metal layer 110 between the two SSE sheets. Other combinations of layers and compositions of layers may be used for other types of stacks, such as a cathode stack. In this implementation, the layers forming the electrode stack 102 are fed between the calender rollers 114, 116 in an Aluminum-SSE-Lithium-SSE-Aluminum stack. When assembled into a cell, the anode is comprised of the SSE-Lithium-SSE stack where the aluminum foil has been removed. The composite SSE layers 106 in this configuration may conduct ions, but not electrons, during use in a battery cell such that the SSE layers provide electrical isolation for the middle lithium anode material of layer 110. As explained in more detail below, the respective rollers of the calender press 104 are spaced apart a distance less than the pre-calendered stack thickness such that pressure on the stack being fed between the calender rollers 114, 116 may reduce the porosity of the materials within the stack, enhance material contact, cause some layers to adhere or bond, and/or cause the SSE layers 106 to partially or completely separate from the aluminum foil 108 while laminating to the lithium foil 110 layer. It should be recognized that in some instances, the calender press does not delaminate the outer foil layer and a subsequent delamination operation may be used. In other instances, the calendering process weakens the SSE adhesion to the outer foil making subsequent removal more efficient. The pressure exerted by the calender rollers 114, 116 on the stack may be adjusted through a calender controller 112 configured to adjust the space between the calender rollers. Upon removal of the aluminum foil 108 from the stack, an SSE-Li-SSE stack is produced that may then be used as an anode in an electrochemical cell. Other stacks may include the same or different types of layers or compositions of layers for use in an electrochemical cell.

As discussed above, conventional lithium-battery anodes are produced by mixing a graphite slurry with multiple ingredients, coating the slurry onto a foil layer, and quickly drying the coated slurry/layer. In contrast, the electrode laminate 102 of FIG. 1 uses a lithium foil 110 with no slurry mixture. Further, the lithium anode 110 is not coated onto a foil as the graphite anode may be. Rather, the lithium anode 110 foil is laminated between the two SSE layers 106 through the calender press device 104. In one implementation, the lithium foil 110 may be a sheet between 30-50 microns of thickness, although other thicknesses may be used. In still other implementations, the anode layer 110 may be of another material, such as graphite, silicon, copper, etc. or combination of materials, such as a layer of copper with lithium deposited on the copper layer, a lithium alloy such as Li—Al (Lithium-Aluminum), Li—Mg (Lithium-Magnesium), Li—In ((Lithium-Indium), each with a lithium content of 5% to 99.9%, 10% to 99%, 20% to 98%, 50% to 95%, among others. Such lithium deposition may include ALD (Atomic Layer Deposition) coating, electrochemical plating, lamination, vapor deposition, etc.

The SSE layer 106 may comprise, in some implementations, a sulfide-based material that is cast onto an aluminum foil layer 108. The SSE layer 106 may also include a binder solution and/or a solvent prepared in a slurry form. In other words, an SSE slurry may be mixed, coated onto the aluminum foil 108, and dried. The binder material included in the SSE slurry may be polymer-based binders, such as but not limited to, polystyrene, ethylene butyl acrylate (EBA), and the like. In some embodiments, the binder may include fluororesin containing vinylidene fluoride (VdF), hexafluoropropylene (HFP), tetrafluoroethylene (TFE), and derivatives thereof as structural units. Specific examples thereof may include homopolymers such as polyvinylidene fluoride (PVdF), polyhexafluoropropylene (PHFP), and polytetrafluoroethylene (PTFE), and binary copolymers such as copolymers of VdF and HFP such as poly (vinylene difluoride-hexafluoropropylene) copolymer (PVdF-HFP), and the like. In another embodiment, the binder may be one or more of a thermoplastic elastomer, such as but not limited to styrene-butadiene rubber (SBR), styrene-butadiene-styrene copolymer (SBS), styrene-isoprene block copolymer (SIS), styrene-ethylene-butylene-styrene (SEBS), polyacrylonitrile (PAN), nitrile-butylene rubber (NBR), polybutadiene, polyisoprene, poly (methacrylate) nitrile-butadiene rubber (PMMA-NBR) and the like. In a further embodiment, the binder may be one or more of an acrylic resin such as but not limited to polymethyl(meth)acrylate, polyethyl(meth)acrylate, polyisopropyl(meth)acrylate, polyisobutyl(meth)acrylate, polybutyl(meth)acrylate, and the like. In yet another embodiment, the binder may be one or more of a polycondensation polymer such as but not limited to polyurea, polyamide paper, polyimide, polyester, and the like. In yet a further embodiment, the binder may be one or more of a nitrile rubber such as but not limited to acrylonitrile-butadiene rubber (ABR), polystyrene nitrile-butadiene rubber (PS-NBR), ethylene propylene diene monomer rubber (EPDM), and mixtures thereof.

In one implementation, the slurry may include 1-20% of the binder material such that the SSE layer 106 sufficiently sticks to the lithium foil layer 110, while the aluminum layer 108 may be peeled away from the SSE layer after the calender 104 laminates the stack. Further, in some implementations, each of the SEE layers 106 may be between 10-100 microns thick, although other thicknesses may be used. As noted above, the SSE slurry may be coated onto an aluminum foil 108 on one side and dried. In some implementation, the aluminum foil 108 may be between 10-30 microns thick, although other thicknesses may be used.

To produce the solid-state electrode laminate 102, the layers may be fed through a calender press device 104 in an Aluminum-SSE-Lithium-SSE-Aluminum layered stack. The calender press 104 may comprise a first roller 114 and a second roller 116 between which the solid-state electrode laminate 102 may be passed. The opposing cylindrical faces of the respective rollers 114,116 exert a compressive pinching force on the stack 102 to press the layers together. In one implementation, the pressure exerted on the stack 102 may reduce the porosity of the materials within the stack and cause the layers to adhere. For example, the calender press 104 may cause the SSE layers 106 to adhere to the lithium layer 110. This densification of the stack 102 may cause the SSE layers 106 to press into the conductive layer 110 and generate adhesion between the layers. In addition, the adhesion between the SSE layers 106 and the respective carrier foil layers 108 may lessen such that the outer layer foil may be peeled from the pressed stack 102 in a controlled manner.

The pressure applied to the stack 102 may correlate to the spacing 118 between the first roller 114 and the second roller 116, among other factors such as temperature of the stack. The spacing may be fixed or may be adjustable and may be adjustable by a controller 112. For example, the controller 112 may increase or decrease the distance 118 between the rollers 114, 116. As explained in more detail below, the spacing 118 of the calender press 104 may be based on feedback information received from the rollers 114,116 or other sensory components associated with the manufacturing of the SSE laminate 102. The feedback may be related to the thickness of the stack, force or other measurements, and the like.

In one particular implementation, the spacing 118 of the calender press 104 may be based on the thickness of the layers of the stack 102. For example, the spacing 118 of the calender press 104 may be set as a function of the thickness of lithium layer 110 and some percentage of the thickness of the SSE layers 106. In one particular implementation, the spacing 118 may be:

Calender Spacing=Li_{Thickness}(0.6*SSE_{Thickness}+Carrier Foil_{Thickness})*2

In some instances, the thickness of the layers may be measured prior to pressing such that the spacing 118 of the calender press 104 may be set accordingly. In other instances, the thickness of the layers may be estimated through a process of measuring the thicknesses prior to assembly (prior to the layers being stacked) and a known rate of thinning of the layers based on the composition of each layer may be applied to the measured thickness. In general, however, it should be appreciated that the spacing 118 of the calender press 104 may correspond to a different correction factor depending on separator composition.

In addition, the spacing 118 of the calender press 104 may be varied through the controller 112 of the press. In particular, one or both of the calender rollers of the press 104 may be adjustable to increase or decrease the spacing 118 between the rollers 114, 116. The spacing 118 may be input to the controller 112, such as through a user input device connected to the controller, to set the spacing. In another implementation, one or more sensors may be associated with the calender press 104 and provide an output to the controller 112 which may control the spacing 118 in response. For example, one or more of the rollers 114, 116 may have a pressure sensor to measure the pressure exerted by the roller onto the stack 102. In another example, a force sensor may measure the force exerted by the calender press 104. Other sensors may include, but are not limited to, laser thickness sensors, linear variable differential transformer (LVDT) gap sensors, ultrasonic sensors, pressure transducers on the hydraulic or pneumatic cylinders of the calender press, infrared (IR) sensors or thermocouples for web or calender temperatures, and the like. The sensor may provide the measurement to the controller 112 to control the spacing 118 of the calender press 104. For example, the controller 112 may adjust the spacing 118 between the rollers 114, 116 to maintain the measured pressure within a pressure window or at a distinct pressure value. In this manner, the calender press 104 may respond to a measurement provided by the one or more sensors. Other sensor inputs or other types of inputs may also be received at the controller 112 and used to adjust the calender spacing 118.

To vary the spacing 118 of the rollers 114, 116 of the calender press 104, each roller may be mounted on an adjustable track that lowers and/or raises one or both of the rollers. For example, the upper roller 114 may include an axle that passes through the center of the roller and is supported on either end from above or below through adjustable upright supports. Each upright support of the axle may be vertically adjustable to raise or lower the axle and, with it, the upper roller 114. The lower roller 116 may include a similar support structure that includes an axle passing through the center of the roller and supported on either end through upright supports. The lower roller 116 may similarly be vertically adjustable by vertically extending or contracting the upright supports of the axle. The upper roller 114 and the lower roller 116 may be independently controlled to vary the spacing 118 between the rollers. In another implementation, the upper roller 114 or the lower roller 116 may be stationary such that the spacing 118 between the rollers is adjusted through the vertical movement of the opposite roller.

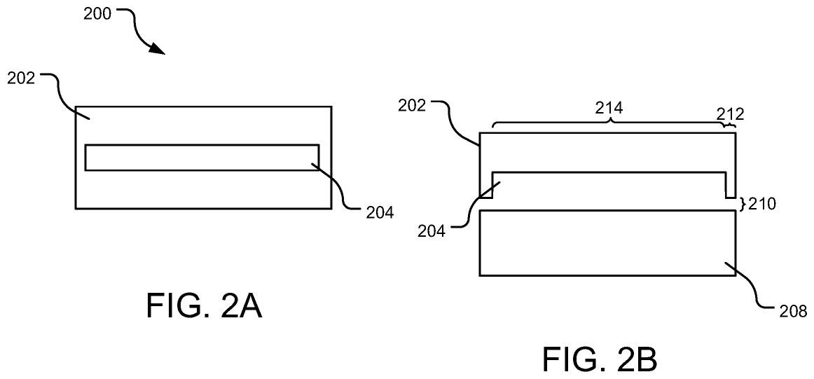

Another implementation of the manufacturing process for a solid-state electrode laminate 102 using a calender press device 104 is now described with reference to FIGS. 2A-2B. In particular, FIG. 2A illustrates a front view of an alternate calender roller 202 that may be used in the manufacturing process described above and FIG. 2B illustrates a cross-section view the alternate calender roller 202 and a second roller 208, also of the same form as roller 202. One of the rollers 202, 208 may include at least one notch 204 spanning the length the roller or at least of the width of whatever stack will be processed or slightly greater than the width. For example, an upper roller 202 may include a notch 204 in the surface of the roller along the length of the upper roller. In an alternate example, a lower roller 208 may include a notch in the surface along the length of the lower roller. In still another example, both the upper roller 202 and the lower roller 208 may include a respective notch. The notch is shown as rectangular in the section view; however, the notch may be other shapes such as triangular in section, circular in section, and others. In general, the radius on the outer corner of the notch 204 should be sharp enough such that a clean break with the layers of the stack is achieved, but not so sharp that the notch edge is fragile or irregular. In one example, if there are multiple notches, such notches are equidistantly spaced such as by being separated by 180 degrees if two notches, 120 degrees if three notches, and 90 degrees if four notches. When paired on the upper roller 202 and the lower roller 208, the notches in the respective rollers may align when facing each other and facing the stack between the rollers. As above, the rollers 202, 208 may be oriented such that an adjustable spacing 210 is between the upper and lower rollers.

During pressing, the notch 204 of the respective roller 202 may define a corresponding portion of the laminate stack 102 where the layers are not compressed and laminated. For example and with reference to FIG. 1, as the layers of the stack 102 are fed through the calender press 104, the upper roller 114 may rotate in a counter-clockwise direction and the lower roller 116 may rotate in a clockwise direction to feed the stack 102 through the spacing 118 and compress the stack layers. However, the rollers 114, 116 in this example may have a solid outer surface such that a constant pressure is applied to the stack 102 within the spacing 118 between the rollers. In contrast, the notch 204 of the upper or lower roller of FIGS. 2A and 2B may provide a portion of the roller in which pressure is not exerted onto the stack 102 as it passes between the rollers. For example, in FIG. 2B, the notch 204 of the upper roller 202 may be such that the rollers do not apply a laminating pressure to the stack 102 as the notch aligns with the outer layer of the stack. As the roller 202 rotates as more of the stack is fed between the rollers, the notch 204 may rotate away from the center of the spacing 210 and a laminating pressure may again be exerted on the stack 102.

In one implementation, the notch 204 may be shallow enough such that the recessed portion within the notch comes into contact with the electrode stack while reducing the pressure on the stack. The pressure applied by the recessed portion within the notch 204 may not apply sufficient pressure to laminate the SSE layer to the center lithium layer, allowing for the patch coating process to still take place. Further, the notch 204 in the calender rollers 202, 208 generally does not extend the full length of the roller. The notch 204 may extend less than the full length of the roller 202 to ensure that at least a portion of the upper roller 202 and the bottom roller 208 are in contact with upper and lower carrier foils 108 of the laminate during the lamination process described above. By providing this constant contact with the stack 102, a constant or near constant tension may be maintained on the stack as it is pulled through the calender press 114. If the notch 204 spans the full width of the roller 202, contact between the rollers 202, 208 may be lost and the tension on the stack 102 may drop when the notch in roller 202 faces the roller 208. The width of the notch/gap (214) or the width of the roller that expends past the edge of the notch/gap (212) may be any length such that width 212 is wide enough to prevent deformation of the stack 102 while under the lamination pressure, but is not too wide that the carrier foil 108 can be removed from the separator layer 106 during the peeling process.

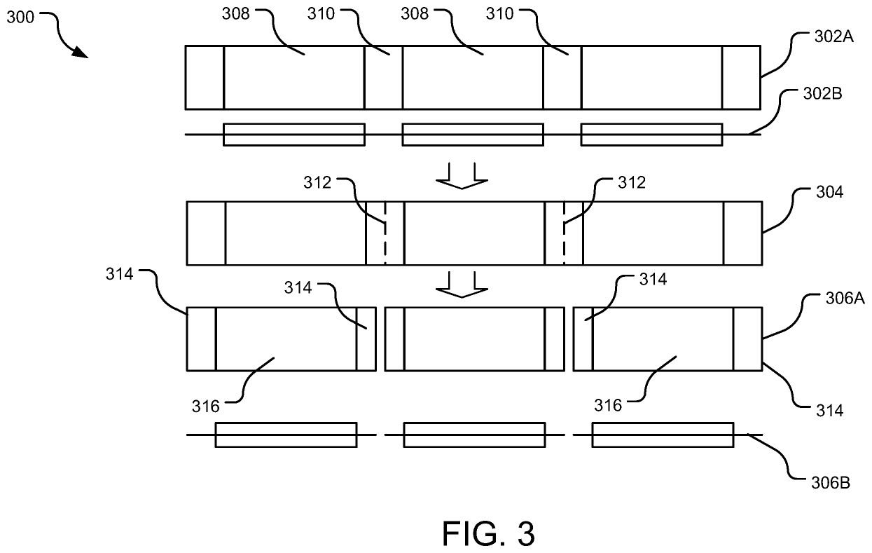

FIG. 3 illustrates top views and side views of solid-state electrode laminates with cut-out portions 310 for separate laminated sections manufactured using a notched calender press, such as that illustrated in FIGS. 2A and 2B. As described above, the roller 202 of a calender press 200 may include a notch 204 in the outer surface such that a laminating pressure is not applied to the electrode stack 102 when the notch portion of the roller is adjacent to the stack as the stack is fed through the calender press. Electrode laminate 302A of FIG. 3 is an illustrated top view and 302B is a side view of the electrode stack that results from using the notched roller 202. The electrode laminate 302 comprises a series of alternating laminated portions 308 and non-laminated portions 310. The laminated portions 308 of the electrode stack 302 coincide with the outer surface of the roller 202 of the calender press that applies a laminating pressure to the stack. In other words, as the electrode stack 102 is fed through the press 104, the portions of the roller 202 without the notch 204 may apply the laminating pressure onto the stack, resulting in the layers adhering together as explained above. Thus, the laminated portions 308 include the laminated Aluminum-SSE-Lithium-SSE-Aluminum stack, from which the aluminum outer foil layers may be removed to generate the laminated SSE-Lithium-SSE electrode. The non-laminated portions 310 of the electrode stack 302 coincide with the notch 204 portion of the roller 202. In particular, as the electrode stack 102 is fed through the press 104, the portions of the roller 202 with the notch 204 may not apply the laminating pressure onto the stack. As these sections 310 of the electrode stack 302 are not pressed by the roller 202, the SSE layers 106 of the stack 102 are not laminated onto or otherwise adhered to the lithium foil 110 layer. Removal of the aluminum layer 108 from the stack 102 may also remove the SSE layer 106 such that the lithium foil layer 110 is exposed in the section 310. The removal of the SSE layer 106 from the lithium layer 110 at sections 310 of the stack 302 may occur on both sides of the stack, although only one side is shown in FIG. 3. As should be appreciated, the width of the exposed sections 310 may coincide to the width of the notch 204 of the roller 202. In this manner, the width of the exposed sections 310 may be controlled through a selection of a width of a roller 202 of the calender press 104. The width of the exposed portions 310 may also be based on a diameter of the notched roller 202, with larger diameters generating wider exposed sections and smaller diameters generating shorter exposed sections.

The exposed 310 portions of the stack 302 may form conductive tabs of a battery electrode, such as an anode. For example, the stack 302 may be cut along the dotted lines 312 illustrated in FIG. 3 of stack 304 and separated as illustrated in stack 306A (top view) and stack 306B (side view) to create multiple electrodes comprising a laminated portion 316 with lithium exposed tabs 314 on either end. The tabs 314 are conductive to the lithium foil layer 110 of the stack such that the electrode may be connected to other electrical components. For example, a load may be connected to a tab 314 of the electrode for receiving a power signal from the electrode when connected within a battery configuration. Through the use of the notched roller 202, multiple solid-state electrode laminates may be generated from a single stack 102 and the manufacturing process described above, with conductive tabs 314 on each end of the electrode laminates. The notched roller 202 allows for easy removal of the SSE layer 106 from the lithium layer 110 (at sections 310) as the SSE layer is not adhered to the lithium layer. This process may be more efficient over previous electrode manufacturing processes that may require multiple steps and devices to attach conductive tabs to the electrode so that the electrode stack may be used in a battery configuration.

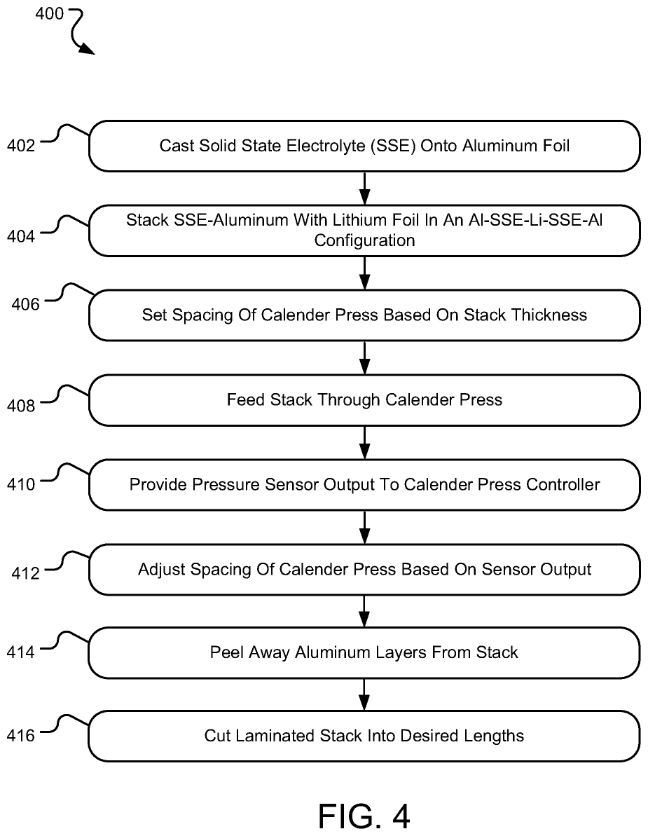

FIG. 4 is a flowchart of a method 400 for a process to manufacture a solid-state electrode laminate using a calender press, according to aspects of the present disclosure. Beginning at step 402, a solid-state electrolyte (SSE) 106 may be mixed and cast onto an aluminum foil 108. The SSE 106 may be a mixed slurry that includes a sulfide-based material, binding agents, and/or a solvent. Other SSEs may be used that includes more or fewer components. As step 404, the cast Al-SSE may be stacked with a lithium foil 110 in an Aluminum-SSE-Lithium-SSE-Aluminum (Al-SSE-Li-SSE-Al) configuration. In some instances, the lithium foil 110 layer of the stack may comprise other types of conducting material, such as graphite or silicon. In still other instances, the aluminum foil layer 108 may comprise a different type of metal or material other than aluminum.

The stacked configuration may be fed through a calender press 104 to laminate the SSE layers 106 onto the lithium foil 110 layer. Thus, at step 406, a spacing 118 of the calender press 104 may be set. In one implementation, the spacing 118 may be manually set by an operator of the press 104. In another implementation, the spacing 118 may be controlled by a calender press controller 112 based on one or more inputs. The inputs to the controller 112 may be provided by an operator of the controller, by a computing device, or from one or more sensors associated with the calender press 104. Further, the spacing 118 of the calender press 104 may be based on the thickness of the stack 102 of materials or on the thickness of any or more of the layers of the stack. At step 408 and following the setting of the spacing 118 of the press 104, the stack 102 may be fed through the calender press for laminating the SSE layers 106 to the lithium foil 110. The stack 102 may be fed between the rollers of the calender press 104 and the rollers may be activated to begin rotating. The rotation of the rollers may pull the stack through the calender press 104 with or without a conveying device to feed the stack through the press. In other words, the stack may be placed between the rollers and the action of the press itself may feed the stack through the press. In other implementations, the stack may be pushed through the calender press 104 through a conveying mechanism, such as a conveyor belt.

At step 410, the output of one or more pressure sensors may be provided to the calender press controller 112 or other computing device. The sensor output may be used by the controller 112 to adjust, at step 412, the spacing 118 of the calender press 104 to maintain a pressure on the stack 102 that is within a tolerance window of pressure values. The process of receiving the pressure sensor outputs and adjusting the spacing of the 118 of the calender press 104 may be an iterative process that occurs continually during laminating of the stack 102. At step 414, the aluminum foil 108 layer of the laminated stack may be peeled away or otherwise removed from the stack 102. In some instances, the pressure applied to the stack 102 by the calender press 104 may aid in peeling the aluminum foil 108 by separating the adhesion between the SSE layers 106 and the respective aluminum foil layer. Thus, as the pressure laminates the lithium layer 110 to the SSE layers 106, the pressure may also separate the SSE layers 106 from the aluminum layer 108 on which the SSE is cast. In another implementation, the aluminum foil layer 108 may be peeled from the SSE layers 106 using a peeling machine or device.

At step 416, the laminated electrode stack 102 may be cut into desired lengths for use in a battery configuration. The laminated stack 102 may be cut into multiple electrodes for use in multiple battery configurations. In some instances, such as when a notched roller 202 is used in the calender press 104, the laminated stack 102 may include portions of exposed lithium layer 310 such that cutting the stack into lengths may include cutting the exposed lithium layer portions to create tabs on the ends of the laminated electrode. Through the process 400 illustrated in FIG. 4, multiple solid-state electrode laminates may be manufactured using a calender press device for use in various types of battery configurations.

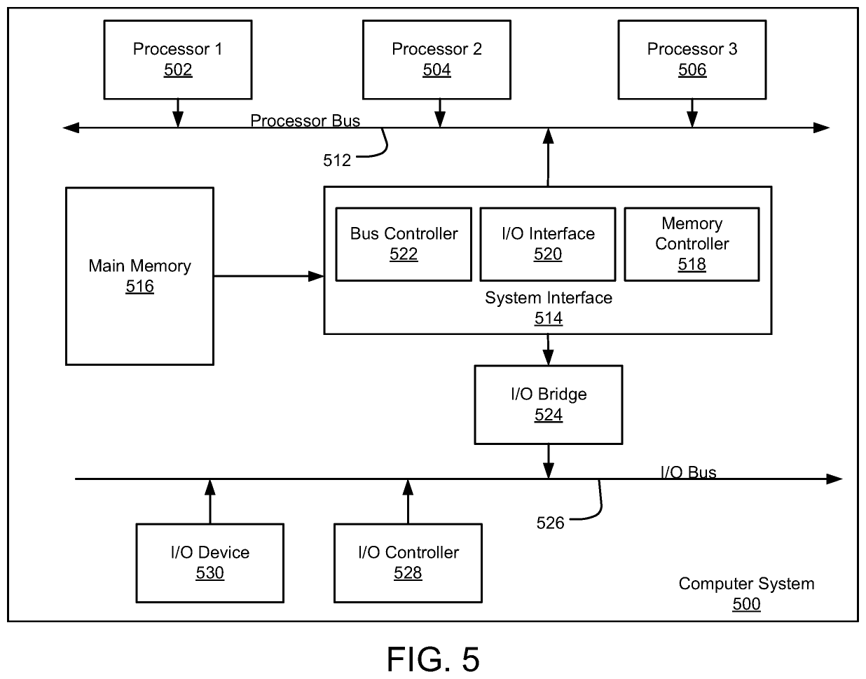

FIG. 5 is a block diagram illustrating an example of a computing device or computer system 500 which may be used in implementing the embodiments of the components of the network disclosed above. For example, the computing system 500 of FIG. 5 may be the controller 112 of the calender press 104 discussed above. The computer system (system) includes one or more processors 502-506. Processors 502-506 may include one or more internal levels of cache (not shown) and a bus controller or bus interface unit to direct interaction with the processor bus 512. Processor bus 512, also known as the host bus or the front side bus, may be used to couple the processors 502-506 with the system interface 514. System interface 514 may be connected to the processor bus 512 to interface other components of the system 500 with the processor bus 512. For example, system interface 514 may include a memory controller 518 for interfacing a main memory 516 with the processor bus 512. The main memory 516 typically includes one or more memory cards and a control circuit (not shown). System interface 514 may also include an input/output (I/O) interface 520 to interface one or more I/O bridges or I/O devices with the processor bus 512. One or more I/O controllers and/or I/O devices may be connected with the I/O bus 526, such as I/O controller 528 and I/O device 530, as illustrated.

I/O device 530 may also include an input device (not shown), such as an alphanumeric input device, including alphanumeric and other keys for communicating information and/or command selections to the processors 502-506. Another type of user input device includes cursor control, such as a mouse, a trackball, or cursor direction keys for communicating direction information and command selections to the processors 502-506 and for controlling cursor movement on the display device.

System 500 may include a dynamic storage device, referred to as main memory 516, or a random access memory (RAM) or other computer-readable devices coupled to the processor bus 512 for storing information and instructions to be executed by the processors 502-506. Main memory 516 also may be used for storing temporary variables or other intermediate information during execution of instructions by the processors 502-506. System 500 may include a read only memory (ROM) and/or other static storage device coupled to the processor bus 512 for storing static information and instructions for the processors 502-506. The system set forth in FIG. 5 is but one possible example of a computer system that may employ or be configured in accordance with aspects of the present disclosure.

According to one embodiment, the above techniques may be performed by computer system 500 in response to processor 504 executing one or more sequences of one or more instructions contained in main memory 516. These instructions may be read into main memory 516 from another machine-readable medium, such as a storage device. Execution of the sequences of instructions contained in main memory 516 may cause processors 502-506 to perform the process steps described herein. In alternative embodiments, circuitry may be used in place of or in combination with the software instructions. Thus, embodiments of the present disclosure may include both hardware and software components.

A machine readable medium includes any mechanism for storing or transmitting information in a form (e.g., software, processing application) readable by a machine (e.g., a computer). Such media may take the form of, but is not limited to, non-volatile media and volatile media and may include removable data storage media, non-removable data storage media, and/or external storage devices made available through a wired or wireless network architecture with such computer program products, including one or more database management products, web server products, application server products, and/or other additional software components. Examples of removable data storage media include Compact Disc Read-Only Memory (CD-ROM), Digital Versatile Disc Read-Only Memory (DVD-ROM), magneto-optical disks, flash drives, and the like. Examples of non-removable data storage media include internal magnetic hard disks, SSDs, and the like. The one or more memory devices 506 may include volatile memory (e.g., dynamic random access memory (DRAM), static random access memory (SRAM), etc.) and/or non-volatile memory (e.g., read-only memory (ROM), flash memory, etc.).

Computer program products containing mechanisms to effectuate the systems and methods in accordance with the presently described technology may reside in main memory 516, which may be referred to as machine-readable media. It will be appreciated that machine-readable media may include any tangible non-transitory medium that is capable of storing or encoding instructions to perform any one or more of the operations of the present disclosure for execution by a machine or that is capable of storing or encoding data structures and/or modules utilized by or associated with such instructions. Machine-readable media may include a single medium or multiple media (e.g., a centralized or distributed database, and/or associated caches and servers) that store the one or more executable instructions or data structures.

Embodiments of the present disclosure include various steps, which are described in this specification. The steps may be performed by hardware components or may be embodied in machine-executable instructions, which may be used to cause a general-purpose or special-purpose processor programmed with the instructions to perform the steps. Alternatively, the steps may be performed by a combination of hardware, software and/or firmware.

Various modifications and additions can be made to the exemplary embodiments discussed without departing from the scope of the present invention. For example, while the embodiments described above refer to particular features, the scope of this invention also includes embodiments having different combinations of features and embodiments that do not include all of the described features. Accordingly, the scope of the present invention is intended to embrace all such alternatives, modifications, and variations together with all equivalents thereof.

While specific implementations are discussed, it should be understood that this is done for illustration purposes only. A person skilled in the relevant art will recognize that other components and configurations may be used without parting from the spirit and scope of the disclosure. Thus, the following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be references to the same embodiment or any embodiment; and, such references mean at least one of the embodiments.

Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any example term. Likewise, the disclosure is not limited to various embodiments given in this specification.

Without intent to limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

We claim:

1. A method for manufacturing a battery electrode, the method comprising:
casting a first solid-state electrolyte (SSE) layer onto a first carrier film and a second SSE layer onto a second carrier film;
layering a conductive foil between and adjacent to the first SSE layer and the second SSE layer as an electrode stack; and
pressing the electrode stack through a pressing device, wherein the pressing device laminates the first SSE layer and the second SSE layer to the conductive foil.

2. The method of claim 1 wherein the conductive foil is a lithium-based foil.

3. The method of claim 1 wherein the SSE layer comprises a sulfide-based solid electrolyte and a binding material.

4. The method of claim 1 wherein the first carrier film and the second carrier film are each an aluminum-based foil.

5. The method of claim 1 wherein the pressing device is a calender press comprising a first roller and a second roller, the first roller oriented above the second roller and separated by a pressing gap.

6. The method of claim 5 wherein the pressing gap is based on a thickness of at least one layer of the electrode stack.

7. The method of claim 6 wherein the pressing gap is based on a thickness of the conductive foil added to a percentage of a thickness of the first SSE layer and the second SSE layer.

8. The method of claim 5 wherein the pressing device is in communication with a controller, the controller adjusting the pressing gap based on at least one of an input or an output of a sensor associated with the calender press.

9. The method of claim 5 wherein at least of the first roller or the second roller comprises a notch portion in an outer surface of roller, the notch portion reducing a laminating pressure on the electrode stack when adjacent to the electrode stack.

10. The method of claim 9 further comprising peeling the first carrier film from the electrode stack, wherein the first SSE layer is removed from the conductive foil at the unlaminated portions of the electrode stack due to the notch portion of the roller.

11. The method of claim 10 further comprising cutting the laminated electrode stack into a length, the cutting corresponding to the unlaminated portions of the electrode stack.

12. The method of claim 1 wherein pressing the electrode stack through a pressing device reduces an adhesion of the first SSE layer to the first carrier film and the second SSE layer to the second carrier film.

13. An electrode for a battery comprising:
a first solid-state electrolyte (SSE) layer comprising a solid electrolyte material and a binder;
a conductive layer adjacent to the first SSE layer; and
a second SSE layer comprising the solid electrolyte material and the binder and adjacent to the conductive layer, wherein the conductive layer is laminated to the first SSE layer and the second SSE by pressure applied to the layers from a calender press.

14. A method for manufacturing a battery electrode, the method comprising:
compressing an electrode stack comprising a first carrier film layer, a first solid-state electrolyte (SSE) layer adjacent the first carrier film layer, a conductive foil adjacent the first SSE layer, a second SSE layer adjacent the conductive foil, and a second carrier film adjacent the second SSE layer, wherein the compression laminates the first SSE layer and the second SSE layer to the conductive foil.

15. The method of claim 14 wherein compressing the electrode stack comprises feeding the electrode stack between a first roller and a second roller, the first roller oriented above the second roller.

16. The method of claim 15 further comprising:
determining a thickness of at least one layer of the electrode stack; and
setting a pressing gap between the first roller and the second roller based on the thickness of the at least one layer of the electrode stack.

17. The method of claim 16 further comprising:
determining a thickness of the conductive foil added to a percentage of a thickness of the first SSE layer and the second SSE layer.

18. The method of claim 16 wherein the pressing gap is based on the equation Li_{Thickness}+(0.6*SSE_{Thickness}+Carrier Foil_{Thickness})*2, wherein Li_{Thickness} is a thickness of the conductive foil, SSE_{Thickness} is a thickness of the first SSE layer or the second SSE layer, and Carrier Foil_{Thickness} is a thickness of the first carrier film or the second carrier film.

19. The method of claim 16 wherein determining the thickness of at least one layer of the electrode stack comprises receiving an output of a pressure sensor measuring a pressure exerted by the first roller and the second roller onto the electrode stack.

20. The method of claim 16 wherein determining the thickness of at least one layer of the electrode stack comprises receiving an input at a computing device in communication with an adjustable calender press.
